(19) United States
(12) Patent Application Publication
(10) Pub. No.: US 2013/0038243 A1
(43) Pub. Date: Feb. 14, 2013

(54) CURRENT-CONTROLLED STAGES, CONSTANT CURRENT CONTROL SYSTEMS, AND CURRENT CONTROL METHODS FOR DRIVING LEDS

(71) Applicant: Ching-Tsan Lee, Miaoli County (TW)

(72) Inventor: Ching-Tsan Lee, Miaoli County (TW)

(73) Assignee: LEADTREND TECHNOLOGY CORPORATION, Hsinchu (TW)

(21) Appl. No.: 13/549,825

(22) Filed: Jul. 16, 2012

(30) Foreign Application Priority Data
Aug. 12, 2011 (TW) 100128818

(51) Int. Cl. H05B 37/02; H02J 4/00; G05F 1/10

(52) U.S. Cl. 315/297; 323/282; 307/31

(57) ABSTRACT

Disclosure has current-controlling stages, backlight systems and control methods for driving LEDs. A disclosed current-controlling stage has a current controller and a feedback apparatus. The current controller is coupled to a light-emitting device, for making the driving current through the light-emitting device substantially a predetermined value. The current controller has a control node, at which a control voltage substantially controls the driving current. The feedback apparatus influences a compensation voltage based on the control voltage to keep the control voltage substantially around a first predetermined value. The compensation voltage substantially determines an output power of a voltage-controlling stage.

### BACKGROUND

The present disclosure relates generally to backlight modules and more particularly to power supplies for driving the light-emitting devices in a backlight module.

For hand-held or portable devices, such as smart phones and notebook computers, power efficiency, referring to how electric power is used for designed purposes, is always a concern in the art. Only if the electric power of the hand-held or portable devices is plenty and effectively used, then they can last long enough to operate when disconnected from power cords. Backlight consumes considerable electric power that the hand-held or portable devices carry. To save electric power and have higher power efficiency, lots of backlight systems employ light-emitting diodes, LEDs in short, to be their light sources. It has become an issue how to effectively drive LEDs, nevertheless.

FIG. 1 illustrates backlight system 8 in the art. In general, backlight system 8 has three portions: voltage-controlling stage 4, current-controlling stage 6, and a light source with LED chains L₁˜L_{N}, each LED chain having LEDs connected in series. Voltage-controlling stage 4 builds output voltage V_{OUT} at output node OUT, based on both the feedback mechanism provided through feedback node FB and compensation node COM, and the power transferring provided by inductor PRM. Control unit 20 of current-controlling stage 6 controls gate nodes of NMOS transistors N₁˜N_{N} to make currents flowing through LED chains substantially the same, such that each diode in LED L₁˜L_{N} illuminates with substantially the same light intensity. The diode numbers of LED L₁˜L_{N} might be the same or differ from one another.

It seems that each of NMOS transistors N₁˜N_{N} acts as a voltage-controlled current source, the current flowing through which is determined by the control voltage at its gate node. Taking NMOS transistor N₁ as an example, drain-to-source voltage V_{DS} of NMOS transistor N₁ must exceed a minimum value V_{DS-MIN} for NMOS transistor N₁ to perform as a voltage-controlled current source. If drain-to-source voltage V_{DS} exceeds minimum value V_{DS-MIN} too much, nevertheless, NMOS transistor N₁ itself will consume much electric power, lowering the power efficiency for lighting. Accordingly, in order the optimize the power efficiency of backlight system 8, it is better to keep each of drain-to-source voltages of NMOS transistors N₁˜N_{N} higher than and close to minimum value V_{DS-MIN}. In current-controlling stage 6, diode array 12 forwards the minimum one among the drain voltages of NMOS transistors N₁˜N_{N} to control unit 20, which accordingly adjusts, via node CRT, feedback voltage V_{FB} at feedback node FB, such that compensation voltage V_{COM} at compensation node COM and the output power provided by voltage-controlling stage 4 are adjusted.

It is supposed that control unit 20 finds the minimum one among the drain voltages of NMOS transistors N₁˜N_{N} is 0.6V, exceeding a target value of 0.5V. Control unit 20 then pours current through node CRT to raise feedback voltage V_{FB}. To keep feedback voltage V_{FB} substantially the same, all compensation voltage V_{COM}, output power of voltage-controlling stage 4, and output voltage V_{OUT} decrease, such that the minimum one among the drain voltages of NMOS transistors N₁˜N_{N} decreases and approaches to the target value of 0.5V, and the power efficiency of backlight system 8 increases.

If backlight system 8 desires dimming control to periodically turn on and off LED chains L₁˜L_{N}, diode array 12 must endure high voltage when LED chains L₁˜L_{N} are off, and might not be integrated into a monolithic chip with control unit 20. Generally speaking, the more discrete devices the high manufacture cost. Backlight system 8 might need some improvement in view of manufacture cost.

### BRIEF DESCRIPTION OF THE DRAWINGS

The invention can be more fully understood by the subsequent detailed description and examples with references made to the accompanying drawings, wherein:

FIG. 1 illustrates a backlight system in the art;

FIG. 2 demonstrates a backlight system according to one embodiment of the invention; and

FIG. 3 demonstrates a backlight system according to another embodiment of the invention.

### DETAILED DESCRIPTION

In this specification, the devices with the same symbol refer to the devices with substantially the same or similar function, structure, compound or application, but are not necessarily all the same. After reading this specification, persons skilled in the art can replace or alter some devices in the embodiments without departing the essence of the invention. Accordingly, the embodiments herein are not used for limiting the scope of the invention.

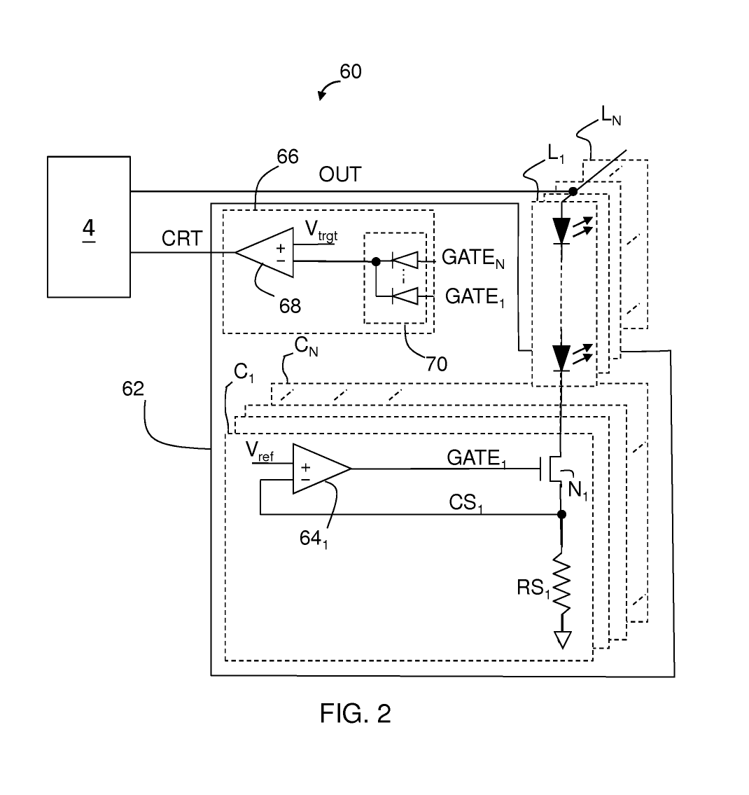

FIG. 2 demonstrates backlight system 60 according to one embodiment of the invention, having voltage-controlling stage 4, current-controlling stage 62, and a light source with LED chains L₁˜L_{N}.

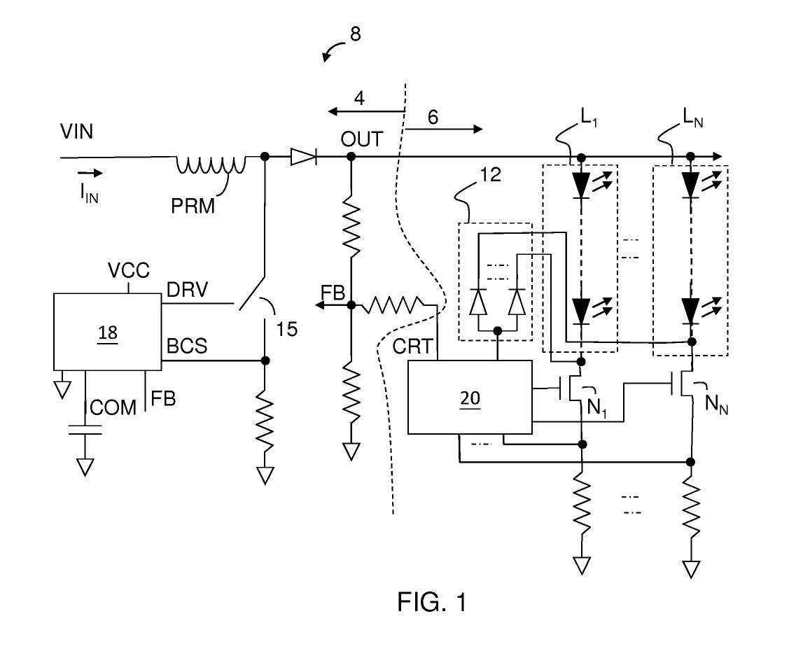

As exemplified in FIG. 1, voltage-controlling stage 4 could be a booster. Shown in FIG. 1, power manager 18 controls the ON and OFF of power switch 15, to determine the output power of voltage-controlling stage 4 and build output voltage V_{OUT} at output node OUT.

Current-controlling stage 62 of FIG. 2 has N current controller C₁˜C_{N}, corresponding to LED chains L₁˜L_{N}, respectively. Anodes of LED chains L₁˜L_{N} are commonly connected to output node OUT. Each cathode of LED chains L₁˜L_{N} is connected to a drain of a corresponding NMOS transistor. It is preferred for current controller C₁˜C_{N} to have a common circuit structure. Based on one current controller disclosed, persons skilled in the art can acknowledge or derive other current controllers without further explanation.

Current controller C₁, for example, has operational amplifier 64₁, NMOS transistor N₁, and detection resistor RS₁. Of operational amplifier 64₁, the non-inverted input is coupled to predetermined voltage V_{ref}, the inverted input to detection resistor RS₁, and the output to gate node GATE₁ of NMOS transistor N₁. Detection resistor RS₁ is coupled between the source of NMOS transistor N₁ and a ground line. NMOS transistor N₁ is a power transistor as large current flows through it when turned on. The control voltage at gate node GATE₁ substantially controls the current through NMOS transistor N₁, which equals to the current through LED chain L₁. Thus, NMOS transistor N₁ is a voltage-controlled current source. It can be derived from the circuit shown in FIG. 2 that current controller C₁ will keep the current through NMOS transistor N₁ substantially a preset constant, equal to V_{ref}/R_{RS1}, where R_{RS1} refers to the resistance of detection resistor RS₁.

Further included in current-controlling stage 62 is feedback apparatus 66, which has operational amplifier 68 and maximum value provider 70. Maximum value provider 70 has a diode array with diodes, each having a cathode commonly coupled to the inverted input of operational amplifier 68 and an anode coupled to a corresponding gate node GATE, of a current controller Cₙ. Supposed that each diode in maximum value provider 70 is ideal, the voltage at the inverted input of operational amplifier 68 will equal to the maximum voltage V_{GATE-MAX} among the control voltages at gate nodes GATE₁˜GATE_{N}. The non-inverted input of operational amplifier 68 is coupled to target voltage V_{trgt}. The output of operational amplifier 68 is coupled to node CRT, which is deemed to be an adjusting node. If the voltage at node CRT is lowered, then the target value that output voltage V_{OUT} approaches is adjusted to increase.

As can be derived from both the circuits of current-controlling stage 62 and voltage-controlling stage 4, at an equilibrium state, the voltage at the inverted input of operational amplifier 68 has substantially the same value as target voltage V_{trgt}. In other words, the maximum voltage V_{GATE-MAX} will be maintained around a value corresponding to target voltage V_{trgt}. For example, it is supposed that target voltage V_{trgt} is 4V and the voltage at the inverted input of operational amplifier 68 is 4.3V in an instant. Accordingly, operational amplifier 68 drains current from node CRT, feedback voltage V_{FB} is decreased, compensation voltage V_{COM} is increased, and output power of voltage-controlling stage 4 is increased, such that output voltage V_{OUT} is increased. The increment of output voltage V_{OUT} implies that control voltages at gate nodes GATE₁˜GATE_{N} should decrease to keep the currents through NMOS transistors N₁˜N_{N} substantially a preset constant. Thus, current controller C₁˜C_{N} decrease the control voltages at gate nodes GATE₁˜GATE_{N}, and the maximum voltage V_{GATE-MAX} is reduced as a result. Correlating to the maximum voltage V_{GATE-MAX}, the voltage at the inverted input of operational amplifier 68 decreases and approaches to target voltage V_{trgt}.

As the maximum voltage V_{GATE-MAX} is kept around a constant value corresponding to target voltage V_{trgt} the minimum channel resistance of NMOS transistor N₁˜N_{N} is kept as a constant, to effectively control the overall power efficiency.

In comparison with backlight system 8 of FIG. 1, backlight system 60 of FIG. 2 does not need diode array 12 of FIG. 1, and feedback apparatus 66 confronts no high voltages occurring at the drains of NMOS transistor N₁˜N_{N}. Thus, it is possible for feedback apparatus 66 to be integrated into a single monolithic chip with current controllers C₁˜C_{N}. Furthermore, if control unit 20 in FIG. 1 is formed in an integrated-circuit chip, then that chip requires a specific pin dedicated to connect externally to diode array 12. To the opposite, if current-controlling stage 62 is formed in an integrated-circuit chip, that chip does not require such a specific pin because what feedback apparatus 66 detects are control voltages at gate nodes GATE₁˜GATE_{N} inside that chip. Thus, current-controlling stage 62, if formed in an integrated-circuit chip, might have a less pin-count.

Even though the embodiment shown in FIG. 2 drives LED chains L₁˜L_{N}, the invention can be applied to embodiments driving a single LED chain or a single LED. One embodiment of the invention, for example, has the same circuit as backlight system 60 in FIG. 2, but the current-controlling stage 62 therein has only one current controller C₁ and the light source therein has only one LED chain L₁.

Even though FIG. 2 exemplifies an embodiment with voltage-controlling stage 4 being a booster, the invention is not limited to. Persons skilled in the art could employ other power converter topologies in the art, such as flyback converters, buck converters, buck-boosters, or the like, to replace voltage-controlling stage 4 of FIG. 2 while embodying the invention.

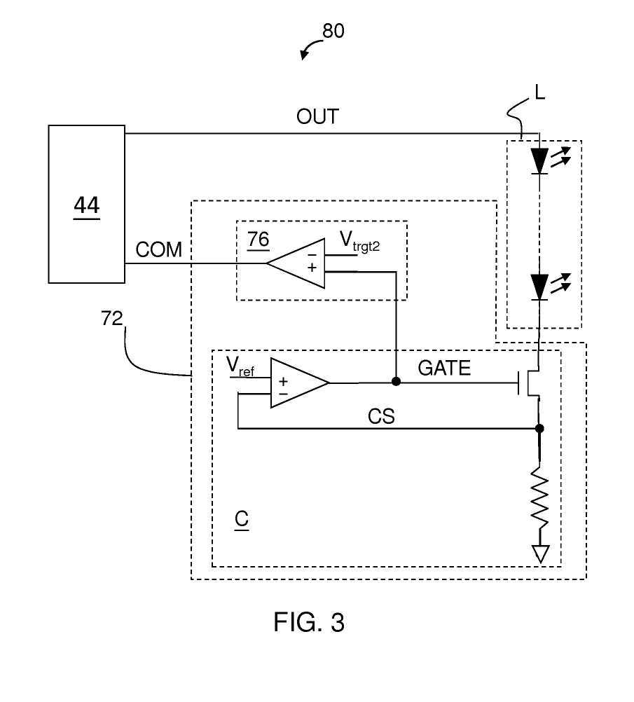

FIG. 3 demonstrates backlight system 80 according to another embodiment of the invention. Voltage-controlling stage 44 could be any kind of power converters, such as booster, flyback converter, buck converter, buck-booster, and the like, to provide output voltage V_{OUT} at output node OUT. Voltage-controlling stage 44 has compensation node COM, the compensation voltage V_{COM} at which substantially determines the output power output from output node OUT from voltage-controlling stage 44. For example, the higher the compensation voltage V_{COM}, the more the output power output provided from voltage-controlling stage 44. Current-controlling stage 72 has current controller C and feedback apparatus 76. The connection and operation of current controller C can be derived or understood by persons skilled in the art based on a previous embodiment, such that the relevant explanation is omitted herein for brevity. Feedback apparatus 76 is an operational amplifier, whose inverted input is coupled to target voltage V_{trgt2}, non-inverted input to gate node GATE, and output to compensation node COM.

Similar to the analysis of FIG. 2, if gate node GATE in FIG. 3 is lower than target voltage V_{trgt2}, compensation voltage V_{COM} at compensation node COM will be decreased by feedback apparatus 76, and output voltage V_{OUT} at output node OUT decreases. Accordingly, current controller C will raise control voltage V_{GATE} at gate node GATE, approaching target voltage V_{trgt2}. Thus, in an equilibrium state, control voltage V_{GATE} is kept to be about target voltage V_{trgt2}, and the current through diode chain L is substantially a preset constant.

While the invention has been described by way of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A current-controlling stage adapted for a backlight module, wherein the backlight module has a voltage-controlling stage outputting an output voltage at an output node, the voltage-controlling stage provides a compensation voltage substantially determining an output power of the voltage-controlling stage, and the backlight module has a light-emitting device with one node coupled to the output node, the current-controlling stage comprising:
a current controller coupled to the light-emitting device, for making the driving current through the light-emitting device substantially a predetermined value, wherein the current controller has a control node, at which a control voltage substantially controls the driving current; and
a feedback apparatus for influencing the compensation voltage based on the control voltage to keep the control voltage substantially around a first predetermined value.

2. The current-controlling stage of claim 1, wherein the backlight module has light-emitting devices and current controllers corresponding and coupled to the light-emitting devices, the feedback apparatus comprises:
a maximum value provider coupled to the control nodes of the current controllers to provide a major signal corresponding to the maximum one among the control voltages at the control nodes;
wherein the major signal influences the compensation voltage to keep the major signal substantially around a second predetermined value.

3. The current-controlling stage of claim 1, wherein the voltage-controlling stage has a feedback node for controlling the output voltage, and when the control voltage exceeds the first predetermined value the feedback apparatus increases the output voltage via the feedback node.

4. The current-controlling stage of claim 1, comprising:
a power transistor with the control node, a current-input node and a current-output node, the light-emitting device having another node coupled to the current-input node;
a detection resistor coupled between the current-output node and a ground line; and
an operational amplifier with an inverted input, a non-inverted input, and an output, wherein the inverter input is coupled to the detection resistor, the non-inverted input to a predetermined voltage, and the output to the control node.

5. A constant-current control system, comprising:
a voltage-controlling stage for providing an output voltage at an output node;
a load; and
a current-controlling stage, comprising:
a voltage-controlled current source with a control load coupled between the output node and the voltage-controlled current source;
control means coupled to the control node for making the driving current substantially a predetermined value; and
a feedback apparatus for influencing an output power provided by the voltage-controlling stage based on a control voltage at the control node to keep the control voltage substantially around a first predetermined value.

6. The constant-current control system of claim 5, wherein the load has light-emitting diodes.

7. The constant-current control system of claim 5, wherein the voltage-controlling stage is a switching mode power supply with a compensation node and a power switch, a compensation voltage at the compensation node substantially determines the duty cycle of the power switch, and the feedback apparatus influences the compensation voltage based on the control voltage.

8. The constant-current control system of claim 5, wherein the constant-current control system has loads, and the current-controlling stage has voltage-controlled current sources corresponding and coupled to the loads, the feedback apparatus comprises:
a maximum value provider coupled to the control nodes of the voltage-controlled current sources to provide a major signal corresponding to the maximum one among the control voltages at the control nodes;
wherein the major signal influences the output power of the voltage-controlling stage to keep the major signal substantially around a second predetermined value.

9. A current control method adapted for controlling the light intensity of a light-emitting device, comprising:
outputting an output power to build up an output voltage at one node of the light-emitting device;
providing a control voltage to substantially control a driving current through the light-emitting device;
controlling the control voltage to make the driving current substantially a predetermined value; and
influencing, based on the control voltage, the output power to keep the control voltage substantially around a first predetermined value.

10. The current control method of claim 9, adapted for controlling the light intensity of light-emitting devices, comprising:
outputting the output power to build up the output voltage at a common node connected to the light-emitting devices;
providing control voltages, each substantially controlling a corresponding driving current through a corresponding light-emitting device; and
influencing, based on the maximum one among the control voltages, the output power to keep the maximum one substantially around a predetermined value.
